(19) United States
(12) Patent Application Publication
(10) Pub. No.: US 2026/0087868 A1
(43) Pub. Date: Mar. 26, 2026

(54) ENHANCED MEDIA PROCESSING SYSTEMS AND METHODS

(71) Applicant: Glory Ltd., Himeji (JP)

(72) Inventors: Zhiyun SU, Himeji (JP); Yasushi KIMURA, Himeji (JP); Junji MASHIMO, Himeji (JP)

(73) Assignee: Glory Ltd., Himeji (JP)

(21) Appl. No.: 18/895,933

(22) Filed: Sep. 25, 2024

(51) Int. Cl. G07D 11/00; G07D 11/22; G07D 11/32

(52) U.S. Cl. CPC G07D 11/009; G07D 11/22; G07D 11/32

(57) ABSTRACT

In some implementations, a media processing system may receive depository media data indicating a declared amount of depository media that is contained within a depository media container and a unique identifier that associates the depository media container with a user account. The media processing system may receive the depository media container and may identify, based on the unique identifier, the user account. The media processing system may receive the depository media that is no longer contained within the container and may determine, based on the depository media, an actual amount of the depository media. The media processing system may determine whether the declared amount of the depository media and the actual amount of the depository media match. The media processing system may perform an action related to the user account based on whether the declared amount of the depository media matches the actual amount of the depository media.

### BACKGROUND

A secure bag deposit machine is a specialized device designed for the secure deposit of depository media, such as banknotes, coins, and checks. Merchants typically place the depository media in a secure bag, which is then sealed and often tagged with a barcode for tracking purposes. After the merchant deposits the secure bag in the secure bag deposit machine, the secure bag deposit machine stores the secure bag until it is retrieved by a cash-in-transit (CIT) company. The CIT company is responsible for collecting and transporting the secure bags, as well as for performing a detailed verification and validation of the contents of the secure bag.

### SUMMARY

Some implementations described herein relate to a method, including: receiving, by a device, authentication information associated with a user, wherein the user is associated with a user account; authenticating, by the device and based on the authentication information, the user; receiving, by the device, depository media data indicating: a declared amount of depository media that is contained within a depository media container, and a unique identifier that associates the depository media container with the user account; receiving, by the device, the depository media container; receiving, by the device, a request to deposit the depository media within a collection area of the device, wherein the request to deposit indicates the unique identifier of the depository media container; identifying, by the device and based on the unique identifier, the user account; receiving, by the device, the depository media that is no longer contained within the depository media container; determining, by the device and based on the depository media, an actual amount of the depository media; storing, by the device and after determining the actual amount of the depository media, the depository media; determining, by the device, whether the declared amount of the depository media and the actual amount of the depository media match; and performing, by the device, an action related to the user account based on whether the declared amount of the depository media matches the actual amount of the depository media.

Some implementations described herein relate to a media processing system, including: one or more memories; and one or more processors, communicatively coupled to the one or more memories, configured to: receive authentication information associated with a user, wherein the user is associated with a user account; authenticate, based on the authentication information, the user; receive depository media data indicating: a declared amount of depository media that is contained within a depository media container, and a unique identifier that associates the depository media container with the user account; receive the depository media container; receive a request to deposit the depository media within a collection area, wherein the request to deposit indicates the unique identifier of the depository media container; identify, based on the unique identifier, the user account; receive the depository media that is no longer contained within the depository media container; determine, based on the depository media, an actual amount of the depository media; store, after determining the actual amount of the depository media, the depository media; determine whether the declared amount of the depository media and the actual amount of the depository media match; and perform an action related to the user account based on whether the declared amount of the depository media matches the actual amount of the depository media.

Some implementations described herein relate to a non-transitory computer-readable medium storing a set of instructions, the set of instructions including: one or more instructions that, when executed by one or more processors of a media processing system, cause the media processing system to: receive authentication information associated with a user, wherein the user is associated with a user account; authenticate, based on the authentication information, the user; receive depository media data indicating: a declared amount of depository media that is contained within a depository media container, and a unique identifier that associates the depository media container with the user account; receive the depository media container; receive a request to deposit the depository media within a collection area, wherein the request to deposit indicates the unique identifier of the depository media container; identify, based on the unique identifier, the user account; receive the depository media that is no longer contained within the depository media container; determine, based on the depository media, an actual amount of the depository media; store, after determining the actual amount of the depository media, the depository media; determine whether the declared amount of the depository media and the actual amount of the depository media match; and perform an action related to the user account based on whether the declared amount of the depository media matches the actual amount of the depository media.

### BRIEF DESCRIPTION OF THE DRAWINGS

FIGS. 1A-1C are diagrams of an example media processing system, in accordance with some embodiments of the present disclosure.

FIGS. 2A-2D are diagrams of an example associated with enhanced media processing systems and methods, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with enhanced media processing systems and methods, in accordance with some embodiments of the present disclosure.

FIG. 5 is a flowchart of an example process associated with enhanced media processing systems and methods, in accordance with some embodiments of the present disclosure.

### DETAILED DESCRIPTION OF EXAMPLE EMBODIMENTS

The following detailed description of example implementations refers to the accompanying drawings. The same reference numbers in different drawings may identify the same or similar elements.

A secure bag deposit machine (e.g., a freestanding secure bag deposit machine located at a physical location of a financial institution) may be used to collect a secure bag (e.g., a tamper-evident and/or a barcoded bag provided by the financial institution) containing depository media (e.g., banknotes and/or coins processed by the financial institution, among other examples). For example, a user (e.g., a merchant customer of the financial institution) may deposit the secure bag, containing the depository media, into the secure bag deposit machine.

After depositing the secure bag into the secure bag deposit machine, the depository media contained within the secure bag cannot be recirculated, or credited to a user account of the user, until the depository media are verified and/or validated. This process begins with retrieval of the secure bag from the secure bag deposit machine by a cash-in-transit (CIT) company, followed by transportation to a facility of the CIT company. At the facility, the depository media are counted and reconciled with information associated with the secure bag (e.g., provided via the barcode of the secure bag, among other examples) and/or information associated with the depository media contained within the secure bag. This multi-step process introduces delays, as the time required for transportation, verification, and validation can impact the speed at which funds are recirculated and user accounts are credited. Consequently, users may experience a lag in their cash flow, as the user accounts cannot be credited until the entire verification and validation process is complete. This delay can be challenging for businesses with high transaction volumes or those relying on timely access to funds.

Some implementations described herein provide enhanced media processing systems and methods. For example, a media processing system may receive authentication information associated with a user. The user may be associated with a user account. The media processing system may authenticate, based on the authentication information, the user. The media processing system may receive declared depository media data indicating a declared amount of depository media that is contained within a depository media container, and a unique identifier that associates the depository media container with the user account.

The media processing system may receive the depository media container (e.g., through a collection port of a collection device). The media processing system may receive a request to deposit the depository media within the media processing system (e.g., a request to deposit the depository media through an input port leading to a collection area, among other examples). The request to deposit may indicate the unique identifier of the depository media container. The media processing system may identify, based on the unique identifier, the user account.

The media processing system may receive the depository media that is no longer contained within the depository media container. The media processing system may determine, based on the depository media, an actual amount of the depository media. The media processing system may store, after determining the actual amount of the depository media, the depository media. The media processing system may determine whether the declared amount of the depository media and the actual amount of the depository media match. The media processing system may perform an action related to the user account based on whether the declared amount of the depository media matches the actual amount of the depository media.

Accordingly, some implementations described herein enable quick and efficient processing of depository media (e.g., deposited using depository media containers). In this way, the depository media, included in the depository media contents secured in the depository media container, can be quickly recirculated and/or credited to a user account. By performing the processing of the depository media directly by the media processing system, a need for retrieval and transportation by a cash-in-transit (CIT) company is eliminated. This approach enables immediate counting and reconciliation of the depository media based on information associated with the user, the user account, the depository media container, and/or the depository media, which is provided to, and/or otherwise obtained by, the media processing system shortly after the deposit occurs (e.g., within a same day as when the deposit occurs, among other examples).

The expedited on-site processing significantly reduces delays that are typically introduced by typical secure bag processing techniques, such as multi-step processes including transportation, verification, and validation at an external facility (e.g., a CIT facility). As a result, the depository media included in the depository media contents can be recirculated and user accounts credited much faster compared to traditional secure bag processing techniques. As an example, depository media in bulk form within the secure bag is accepted by the media processing system, allowing the depository media to be used as withdrawal media without depending on external facilities, such as a CIT facility. Additionally, customers do not need to insert the depository media individually into the media processing system; the customers can simply insert the secure bag containing the depository media. This provides benefits not only to customers of financial institutions but also to the financial institutions. This swift processing minimizes cash flow lag for businesses, which is beneficial for those with high transaction volumes or those dependent on prompt access to funds.

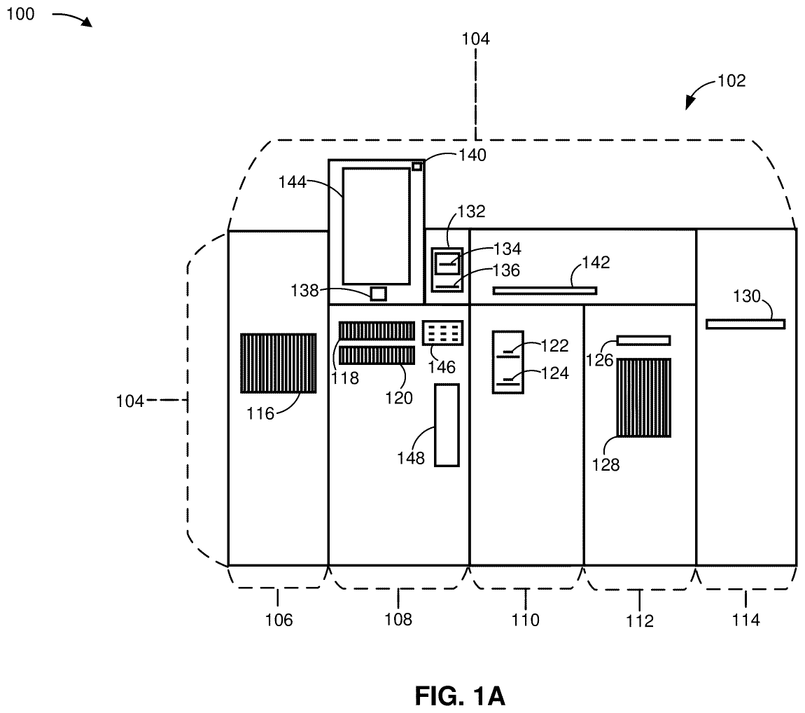

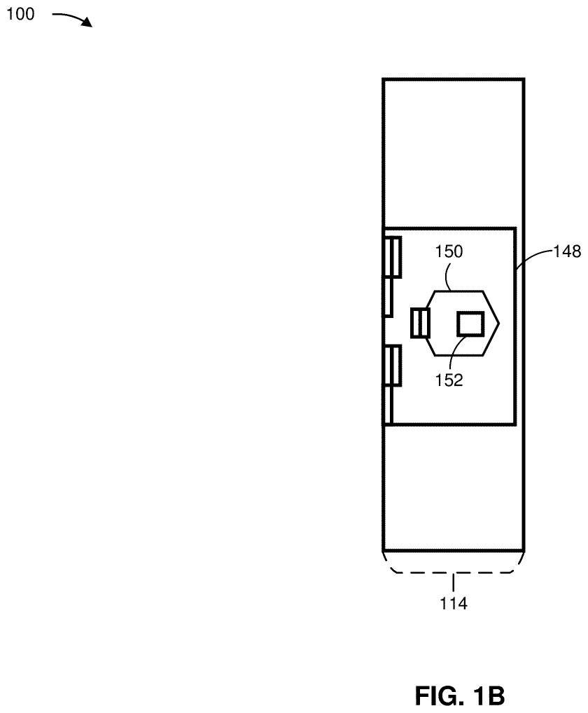

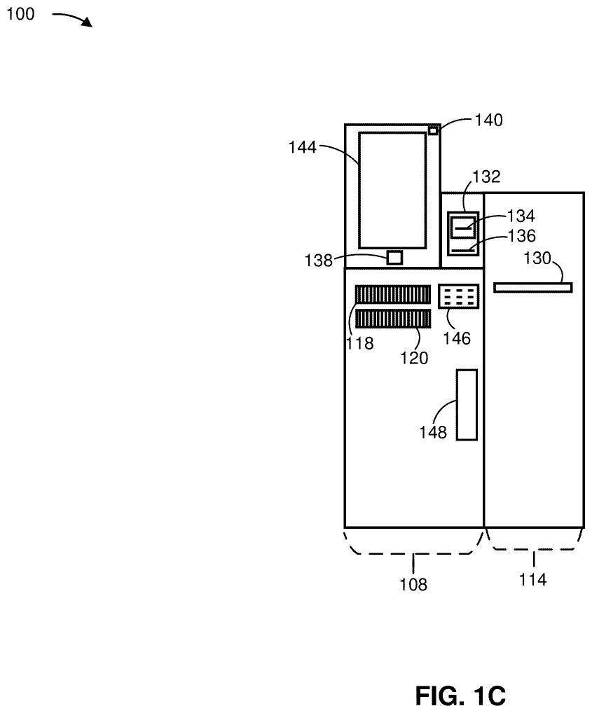

FIGS. 1A-1C are diagrams of an example media processing system 100 (e.g., an enhanced media processing system) as described herein. As shown in FIG. 1A, the media processing system 100 includes a housing 104 that houses one or more components, as described in more detail elsewhere herein.

As further shown in FIG. 1A, the media processing system 100 includes a rolled coin device (e.g., shown as a rolled coin dispenser 106), a banknote device (e.g., shown as a banknote recycler 108), a check device (e.g., shown as a check depositor 110), a loose coin device (e.g., shown as a coin recycler 112) and a collection device (e.g., shown as a secure bag depositor 114). The rolled coin device 106 includes a rolled coin dispense port 116. The banknote device 108 includes a banknote input port 118 and a banknote dispense port 120. The check device 110 includes a check input port 122 and a check dispense port 124. The loose coin device 112 includes a loose coin input port 126 and a loose coin dispense port 128. The collection device 114 includes a collection port 130. For example, a standard mechanical structure may be applied to the banknote device 108. The rolled coin device 106, the check device 110, the loose coin device 112, the collection device 114 are the same.

The media processing system 100 may include multiple peripheral devices (e.g., shown as a code reader 132, a card reader 134, a receipt printer 136, a near field communication (NFC) device 138, an imaging sensor 140, an A4 printer 142, a display 144, and a numeric keypad 146 in FIG. 1A).

In some implementations, one or more components of the media processing system 100 may be controlled via a control device 148 (e.g., a controller and/or a computer that controls one or more components of the media processing system 100, among other examples), as described in more detail elsewhere herein. As an example, the control device 148 may control the rolled coin device 106, the banknote device 108, the check device 110, the loose coin device 112, the collection device 114, and/or one or more of the peripheral devices (e.g., the code reader 132, the card reader 134, the receipt printer 136, the near field communication (NFC) device 138, the imaging sensor 140, the A4 printer 142, and the display 144) to enable one or more automated services to be performed, as described in more detail elsewhere herein.

In some implementations, the media processing system 100 may provide a graphical user interface (GUI), such as via the via the display 144 and the control device 148, to enable interactions between the media processing system 100 and users of the media processing system 100. As an example, the media processing system 100 may present, via the GUI and the display 144, input options (e.g., authentication options, login options, and/or automated service options, among other examples) that may be selected by the users. The media processing system 100 may perform one or more actions in response to the input options selected by the users, as described in more detail elsewhere herein.

In some implementations, the media processing system 100 may be associated with an entity that services and/or manages a user account of a user. For example, the media processing system 100 may be associated with a financial institution that services and/or manages a user account of a user (e.g., a merchant account of a merchant user and/or a consumer account of a consumer user, among other examples). Accordingly, the media processing system 100 may be located at a physical location associated with the financial institution. In this way, the media processing system 100 may enable the user to deposit a depository media container (e.g., a secure bag and/or a secure envelope, among other examples), including depository media contents, within the media processing system 100, as described in more detail elsewhere herein.

To initiate a user deposit process, the media processing system 100 may authenticate an identify of the user using one or more authentication techniques. For example, the media processing system 100 may receive authentication information associated with the user (e.g., username and password information, identification information, deposit slip information, and/or QR code and pin information, among other examples) and may authenticate the identity of the user based on the authentication information. As an example, the media processing system 102 may authenticate an identity of the user using a biometric scanner or a secure PIN code.

After the media processing system 100 authenticates the user, the media processing system 100 may identify a user account of the user (e.g., a merchant account related to the user and managed and/or serviced by the financial institution, among other examples). In this way, details associated with the user deposit process may be properly associated with the user account. For example, the media processing system 100 may identify a user account of the user from a card inserted into the card reader 134.

In some implementations, the media processing system 100 may retrieve information associated with the user account and may present the information via the GUI and the display 144 to be viewed, and/or interacted with, by the user. As an example, the media processing system 100 may present a deposit option to the user. The user may select the deposit option (e.g., by pressing a finger of the user against the display 144 to select the deposit option on the GUI). In response to the user selecting the deposit option, the media processing system 100 may enable the user to provide declared depositary media content information (e.g., declared depository media data), which describes the depository media contents contained within the depository media container.

As an example, the declared depository media content information may include a declared depository media type (e.g., banknotes, such as U.S. Dollars and/or Euros, and/or or loose coins, such as U.S. quarters and/or Euro 50 cent coins, among other examples), a declared depository media number (e.g., a total number of the depository media contents), a declared denomination (e.g., $1, $5, and/or $10, among other examples), and/or a declared amount (e.g., a total declared amount of the depository media contents), among other examples. As an example, the media processing system 100 may present, via the GUI and the display 144, input fields that enable the user to input the declared depository media content information.

After the user provides the declared depository media content information to the media processing system 100 (e.g., as an input via the GUI and the display 144), the user may provide information, as an input to the media processing system 100, that enables the media processing system 100 to link the depository media container, the depository media contents contained within the depository media container, and/or other information associated with the user deposit process performed during the user session, to the user account. As an example, the user may scan (e.g., via the code reader 132) a depository media container identifier (e.g., a barcode and/or a two-dimensional code among other examples) of the depository media container, which enables the media processing system 100 to associate the depository media container, the depository media contents contained within the depository media container, and/or other information associated with the user deposit process performed during the user session.

As an example, the media processing system 100 may decode the scanned information to extract the depository media container identifier. The media processing system 100 may identify the user account of the user based on the depository media container identifier. The media processing system 100 may store the declared depository media content information associated with the user account (e.g., for later processing operations).

After the information associated with the user deposit process has been linked to the user account, the user may deposit the depository media container within the media processing system 100. As an example, the user may insert the depository media container into the collection device 114 via the collection port 130, which may lead to an interior storage area (e.g., a secure safe box located in an interior region of the collection device 114). The interior storage area may be used to store the depository media container (e.g., deposited by the user) for subsequent retrieval and/or processing, as described in more detail elsewhere herein.

In some implementations, the collection device 114 may include a door (e.g., shown as a retrieval door 148 in FIG. 1B) for accessing the interior storage area of the collection device 114. In some implementations, the retrieval door 148 may be designed with security features to ensure safe and controlled access. As an example, the retrieval door 148 may be equipped with a locking mechanism 150 (e.g., an electromagnetic lock, among other examples) having an authentication device 152 (e.g., a numeric keypad, among other examples).

The locking mechanism 150 and the authentication device 152 enable the retrieval door 148 to switch between a locked state and an unlocked state (e.g., based on input from the authentication device 152). For example, an entity user (e.g., an employee of the financial institution) may enter a code which toggles a state of the lock (e.g., from the locked state to the unlocked state). Although the locking mechanism 150 is described as being an electromagnetic lock and the authentication device 152 is described as being a numeric keypad, the locking mechanism 150 may be any suitable locking mechanism and the authentication device 152 may be any suitable authentication device. As an example, the locking mechanism 150 and the authentication device 152 may be a mechanical locking assembly, among other examples.

Accordingly, for example, the entity user may unlock the retrieval door 148 to access the interior storage area and retrieve the depository media container containing the depository media contents. The entity user may remove the depository media contents from the depository media container. The entity user may provide, and the media processing system 100 may receive, the depository media contents. The media processing system 100 may process the depository media contents, as described in more detail elsewhere herein. Accordingly, for example, the media processing system 100 may link the account information from the card with the identifier of the depository media container, allowing the account information to be obtained without the need for the physical card to be present (e.g., associated with the user that deposited the secure bag).

In some implementations, the depository media contents may include banknotes, coins, and/or checks. The media processing system 100 may receive the banknotes via the banknote input port 118 of the banknote device 108, may receive the checks via the check input port 122 of the check device 110, and the coins via the loose coin input port 126 of the loose coin device 112.

In some implementations, the media processing system 100 may receive actual depository media content information (e.g., by processing the received banknotes, the received checks, and/or the received coins). As an example, the actual depository media content information may include an actual depository media type (e.g., actual depository media types included in the depository media contents), an actual depository media number (e.g., an actual total number of depository media included in the depository media contents), an actual denomination (e.g., actual denominations the depository media included in the depository media contents $1, $5, and/or $10, among other examples), and/or an actual amount (e.g., a total actual declared amount of the depository media included in the depository media contents), among other examples.

In some implementations, the media processing system 100 may determine whether the declared depository media content information matches the actual depository media content information (e.g., by comparing the declared depository media content information and the actual depository media content information). As an example, the media processing system 100 may determine whether the declared amount of the depository media included in the depository media contents matches the actual amount of the depository media included in the depository media contents, among other examples.

In some implementations, the media processing system 100 may perform an action related to the user account based on whether the declared depository media content information matches the actual depository media content information. As an example, the media processing system 100 may adjust one or more parameters of the user account based on the declared depository media content information matching the actual depository media content information (e.g., the media processing system 100 may apply a credit to a balance of the user account equal) or not matching the actual depository media content information (e.g., the media processing system 100 may apply a partial credit equal to the actual amount while generating a notification indicating a discrepancy value between the declared amount and the actual amount). Additionally, or alternatively, and even if the content does not match, the media processing system 100 can automatically update the declared value based on the processing result and/or generate information (e.g., a notification) for the customer.

In some implementations, the media processing system 102 may receive different authentication information associated with a different user. The different user may be associated with a different user account. The media processing system 102 may authenticate, based on the different authentication information, the different user. The media processing system 102 may receive a withdrawal request. The media processing system 102 may dispense a portion of the depository media in response to the withdrawal request. The media processing system 102 may adjust a balance of the different user account based on the portion of the depository media.

In this way, because the media processing system 100 quickly and efficiently processes the depository media included in the depository media contents (e.g., shortly after being deposited and at the same location where the deposit occurred), the depository media included in the depository media contents can be quickly recirculated and/or credited to the user account. By performing the processing of the depository media, included in the depository media contents, directly at the media processing system 100, a need for retrieval and transportation by a cash-in-transit (CIT) company is eliminated. This approach enables immediate counting and reconciliation of the depository media, included in the depository media content, based on information associated with the user, the user account, the depository media container, and/or the depository media included in the depository media contents, which is provided to, and/or otherwise obtained by, the media processing system 100 shortly after the deposit occurs (e.g., within a same day as when the deposit occurs, among other examples).

The expedited on-site processing significantly reduces delays that are typically introduced by typical secure bag processing techniques, such as multi-step processes including transportation, verification, and validation at an external facility (e.g., a CIT facility). As a result, the depository media included in the depository media contents can be recirculated and user accounts credited much faster compared to traditional secure bag processing techniques. This swift processing minimizes cash flow lag for businesses, which is beneficial for those with high transaction volumes or those dependent on prompt access to funds.

Although a particular configuration of the rolled coin device 106, the banknote device 108, the check device 110, the loose coin device 112, and the collection device 114 is shown in FIG. 1A and FIG. 1C, the rolled coin device 106, the of the rolled coin device 106, the banknote device 108, the check device 110, the loose coin device 112, and the collection device 114 may be any suitable configuration. As an example, and as shown in FIG. 1C, the media processing system 100 may include only the banknote device 108, the collection device, one or more peripheral devices, and the control device 148.

As indicated above, FIGS. 1A-1C are provided as an example. Other examples may differ from what is described with regard to FIGS. 1A-1C.

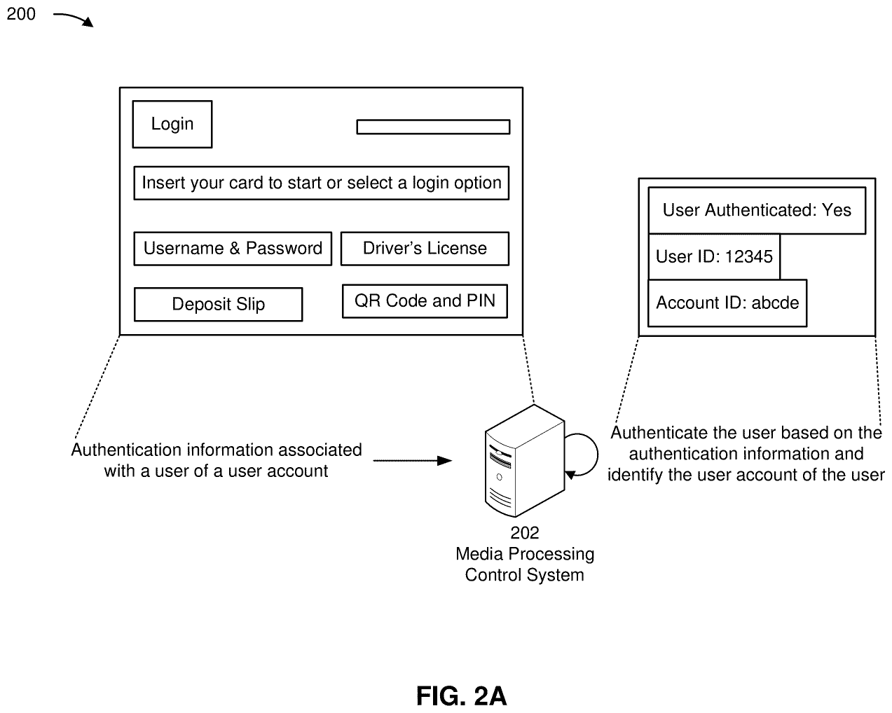

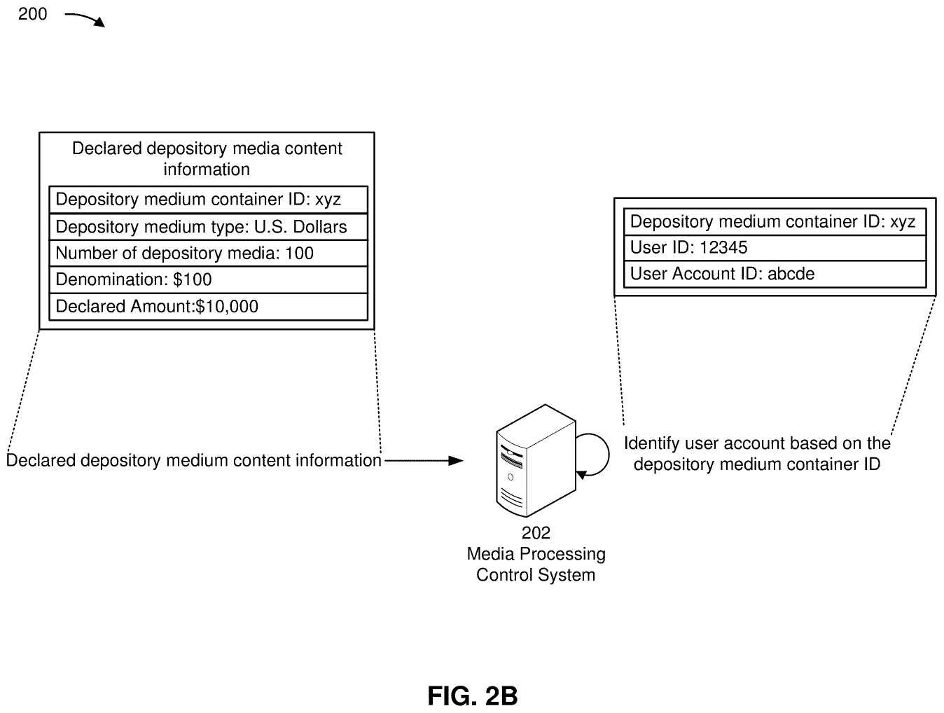

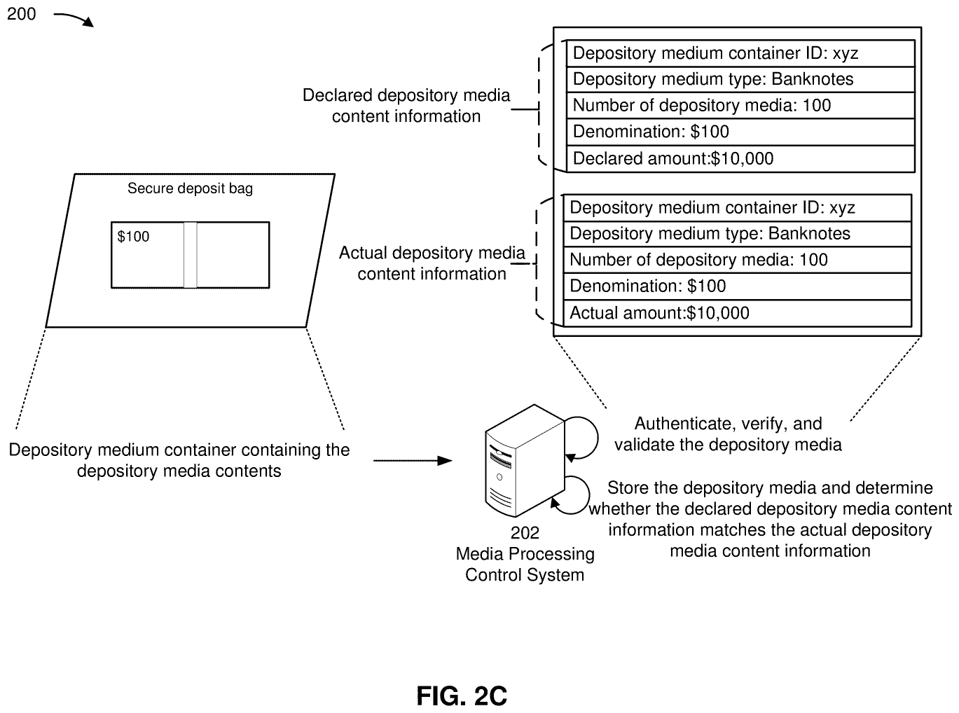

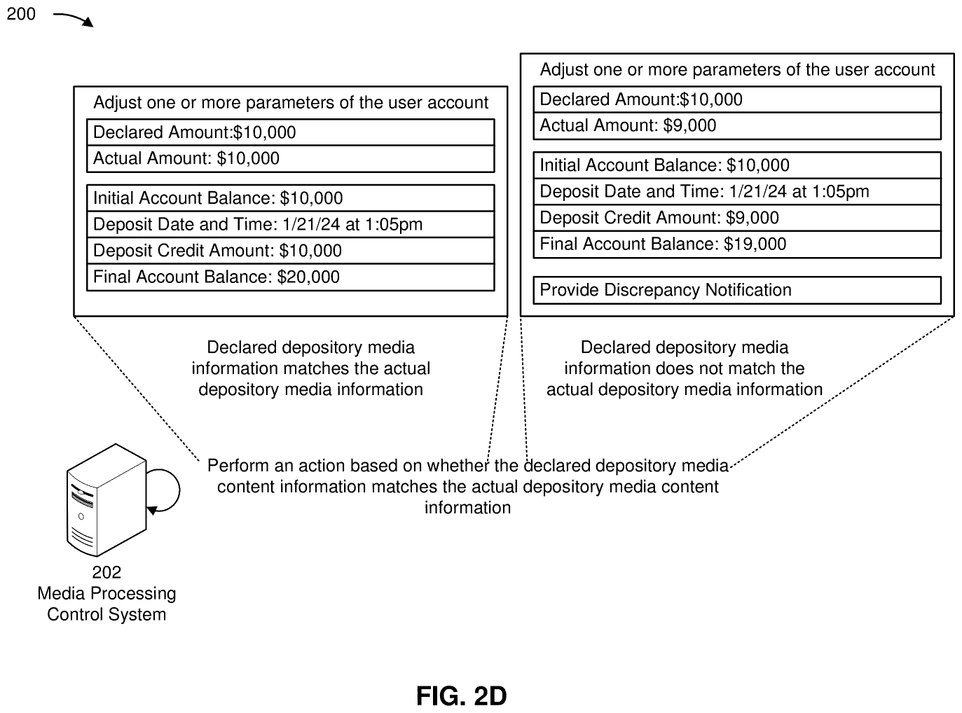

FIGS. 2A-2D are diagrams of an example 200 associated with enhanced media processing systems and methods. As shown in FIGS. 2A-2D, the example 200 includes a media processing control system 202 (e.g., which may correspond to one or more components of the media processing system 100 of FIGS. 1A-1C, among other examples).

As shown in FIG. 2A, the media processing control system 202 may receive authentication information associated with a user of a user account (e.g., as described in more detail elsewhere herein. As an example, the media processing control system 202 may receive the authentication information from a user via interaction with a GUI that presents one or more authentication options (e.g., shown as a username and password authentication option, a driver's license authentication option, a deposit slip authentication option, and a QR code and pin authentication option in FIG. 2A). Although the authentication information is shown as being obtained via a user interaction with the one or more authentication options, the authentication information may be obtained in any suitable manner.

As shown in FIG. 2A, the media processing control system 202 may authenticate the user based on the authentication information and identify the user account of the user (e.g., as described in more detail elsewhere herein).

As shown in FIG. 2B, the media processing control system 202 may receive the declared depository media content information (e.g., as described in more detail elsewhere herein). As further shown in FIG. 2B, the media processing control system 202 may identify the user account based on the depository media container identifier (e.g., as described in more detail elsewhere herein.

As shown in FIG. 2C, the media processing control system 202 may authenticate, verify, and validate the depository media and store the depository media receive the depository media container containing the depository media contents (e.g., as described in more detail elsewhere herein. As further shown in FIG. 2C, the media processing control system 202 may store the depository media and may determine whether the declared depository media content information matches the actual depository media content information (e.g., as described in more detail elsewhere herein.

As shown in FIG. 2D, the media processing control system 202 may perform an action related to the user account based on whether the declared depository media content information matches the actual depository media content information (e.g., as described in more detail elsewhere herein). As an example, the media processing control system 202 may adjust one or more parameters of the user account based on the declared depository media content information matching the actual depository media content information (e.g., as shown in FIG. 2D, the media processing control system 202 may apply a deposit credit amount of $10,000 resulting in a final account balance of $20,000). As another example, the media processing control system 202 may adjust one or more parameters of the user account based on the declared depository media information not matching the actual depository media (e.g., as shown in FIG. 2D, and because of a discrepancy between the declared amount and the actual amount of $1,000, the media processing control system 202 may apply a deposit credit amount of $9,000 resulting in a final account balance of $19,000). Additionally, or alternatively, the media processing system 102 may generate, and/or provide, one or more records, one or more alerts, and/or one or more notifications associated with the user, the user account, and/or the media processing control system 202, among other examples.

As indicated above, FIGS. 2A-2D are provided as an example. Other examples may differ from what is described with regard to FIGS. 2A-2D.

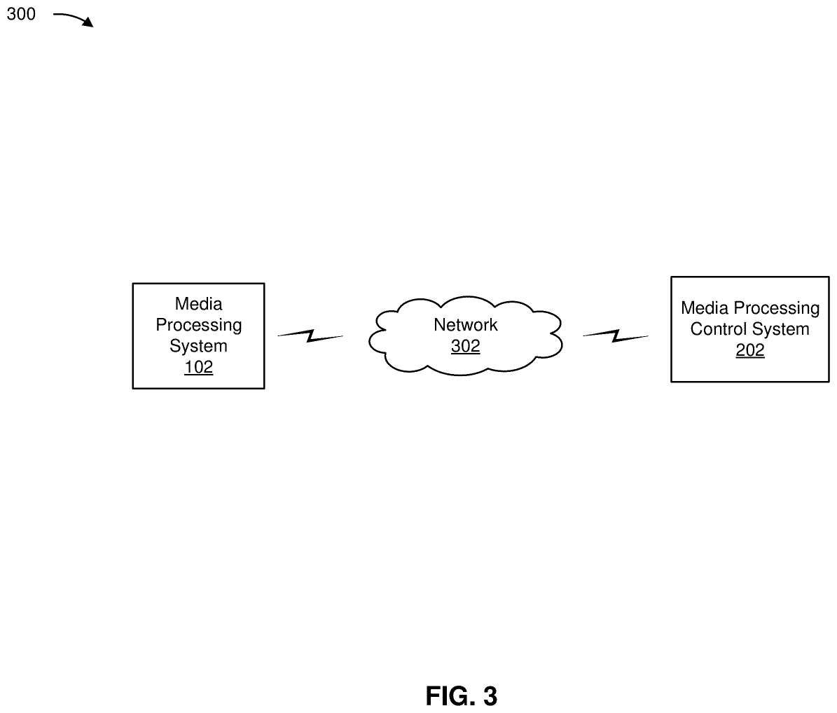

FIG. 3 is a diagram of an example environment 300 in which systems and/or methods described herein may be implemented. As shown in FIG. 3, the environment 300 includes the media processing system 102 (e.g., including one or more components of the media processing system 100), the media processing control system 202, and a network 302. The devices of the environment 300 may interconnect via wired connections, wireless connections, or a combination of wired and wireless connections.

The media processing system 102 may include one or more devices capable of receiving, generating, storing, processing, providing, and/or routing information associated with enhanced media processing systems and methods, as described in more detail elsewhere herein. The media processing system 102 may include a communication device and/or a computer. For example, the media processing system 102 may include a server, such as an application server, a client server, a web server, a database server, a host server, a proxy server, a virtual server (e.g., executing on computing hardware), or a server in a cloud computing system, among other examples. In some implementations, the media processing system 102 may include computing hardware used in a cloud computing environment.

The media processing control system 202 may include one or more devices capable of receiving, generating, storing, processing, providing, and/or routing information associated with enhanced automated service systems and methods, as described in more detail elsewhere herein. The media processing control system 202 may include a communication device and/or a computer. For example, the media processing control system 202 may include a server, such as an application server, a client server, a web server, a database server, a host server, a proxy server, a virtual server (e.g., executing on computing hardware), or a server in a cloud computing system, among other examples. In some implementations, the media processing control system 202 may include computing hardware used in a cloud computing environment.

In some implementations, the media processing system 102 and/or the media processing control system 202 may include one or more backend systems (e.g., including software, databases, and/or infrastructure, among other examples) that support operations and/or services associated with an entity. For example, if the media processing system 102 and/or the media processing control system 202 is associated with a financial institution, then the one or more backend systems may include one or more systems associated with supporting various aspects of banking transactions and/or banking activities (e.g., user transactions, account management, risk assessment, regulatory compliance, and/or reporting, among other examples).

In some implementations, the one or more backend systems may include a core banking system (e.g., serving as a central repository for user account information, transaction records, and/or balances, among other examples). The core banking system may be used to facilitate banking functions, such as deposit and withdrawal processing, fund transfers, loan management, and/or interest calculations, among other examples).

In some implementations, the one or more backend systems may include a payment processing systems that supports (or handles) processing and settlement of various payment transactions, including credit card transactions, automated clearing house (ACH) transfers, wire transfers, and/or electronic funds transfers (EFT), among other examples). In other words, the payment processing system may be used to for movement of funds between accounts and across different payment networks.

In some implementations, the one or more backend systems may include a risk management system (e.g., for assessing and/or mitigating various types of risks, a compliance and regulatory reporting system (e.g., for automating processes associated with monitoring regulatory compliance, generating required reports, and/or submitting regulatory filings to ensure adherence to applicable laws and regulations, among other examples), and/or a customer relationship management (CRM) system (e.g., for enabling banks to manage their interactions and relationships with users by storing user information, by tracking interactions of users, and/or by facilitating marketing campaigns, among other examples).

Although the one or more backend systems are described herein as including a core banking system, a payment processing system, a risk management system, a compliance and regulatory reporting system, and a CRM system, the one or more backend systems may include any suitable backend system.

The network 302 may include one or more wired and/or wireless networks. For example, the network 302 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks, among other examples. The network 302 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

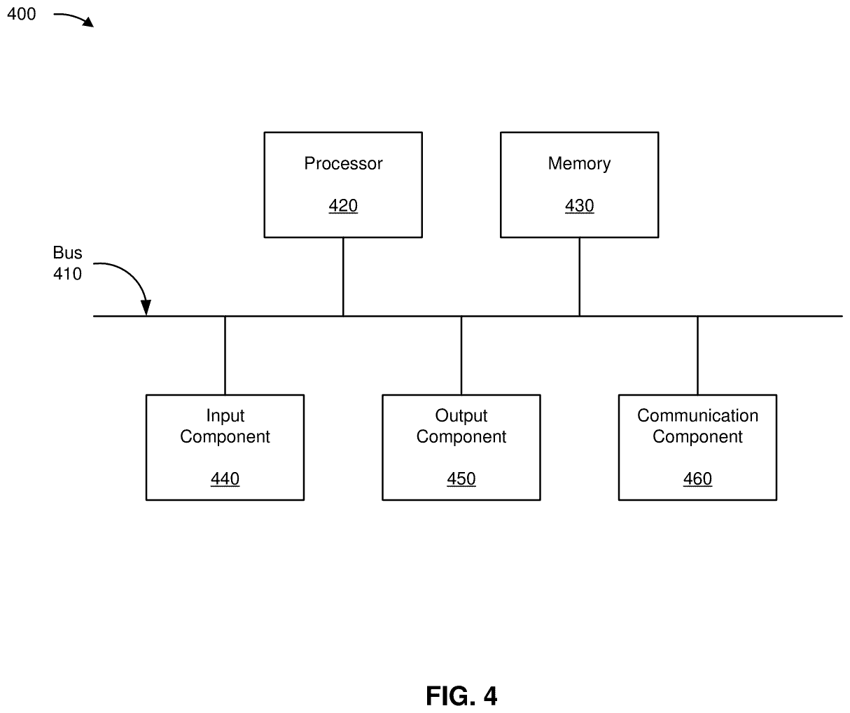

FIG. 4 is a diagram of example components of a device 400 associated with enhanced media processing systems and methods. The device 400 may correspond to the media processing system 102 (e.g., including one or more components of the media processing system 102) and/or the media processing control system 202. In some implementations, the media processing system 102 (e.g., including one or more components of the media processing system 102) and/or the media processing control system 202 may include one or more of the devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more of the processors 420, causes the one or more of the processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

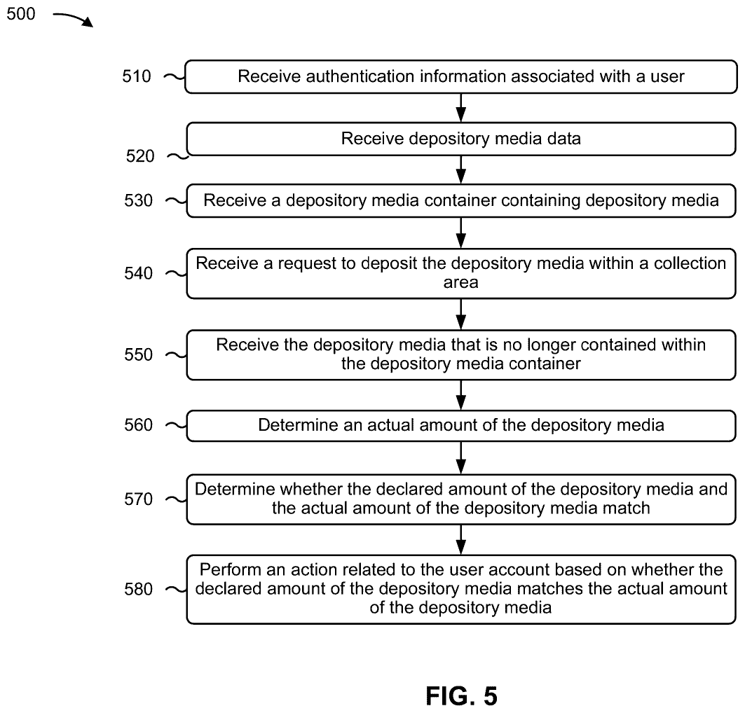

FIG. 5 is a flowchart of an example process 500 associated with enhanced media processing systems and methods. In some implementations, one or more process blocks of FIG. 5 may be performed by media processing system 102 (e.g., including one or more components of the media processing system 102) and/or the media processing control system 202. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, the process 500 includes receiving authentication information associated with a user (block 510). For example, the media processing system 102 may receive authentication information associated with a user, as described in more detail elsewhere herein. The media processing system 102 may authenticate the user based on the authentication information.

As further shown in FIG. 5, the process 500 includes receiving depository media data (block 520). For example, the media processing system 102 may receive depository media data indicating a declared amount of depository media that is contained within a depository media container, and a unique identifier that associates the depository media container with the user account, as described in more detail elsewhere herein.

As further shown in FIG. 5, the process 500 includes receiving a depository media container containing depository media (block 530). For example, the media processing system 102 may receive a depository media container containing depository media, as described in more detail elsewhere herein.

As further shown in FIG. 5, the process 500 includes receiving a request to deposit the depository media within a collection area (block 540). For example, the media processing system 102 may receive a request to deposit the depository media within a collection area, as described in more detail elsewhere herein. In some implementations, the request to deposit may indicate the unique identifier of the depository media container. The media processing system 102 may identify, based on the unique identifier, the user account. Accordingly, for example, the media processing system 100 may link the account information from the card with the identifier of the depository media container, allowing the account information to be obtained without the need for the physical card to be present (e.g., associated with the user that deposited the secure bag).

As further shown in FIG. 5, the process 500 includes receiving the depository media that is no longer contained within the depository media container (block 550). For example, the media processing system 102 may receive the depository media that is no longer contained within the depository media container, as described in more detail elsewhere herein.

As further shown in FIG. 5, the process 500 includes determining an actual amount of the depository media (560). For example, the media processing system 100 may determine, based on the depository media, an actual amount of the depository media, as described in more detail elsewhere herein. In some implementations, the media processing system 102 may store, after determining the actual amount of the depository media, the depository media (e.g., to be recirculated at a later time).

As further shown in FIG. 5, the process includes determining whether the declared amount of the depository media and the actual amount of the depository media match (570). For example, the media processing system 102 may determine whether the declared amount of the depository media and the actual amount of the depository media match, as described in more detail elsewhere herein.

As further shown in FIG. 5, the process includes performing an action related to the user account based on whether the declared amount of the depository media matches the actual amount of the depository media (580). For example, the media processing system 102 may perform an action related to the user account based on whether the declared amount of the depository media matches the actual amount of the depository media, as described in more detail elsewhere herein.

In some implementations, the action includes adjusting a balance of the user account based on the declared amount of the depository media and the actual amount of the depository media. In some implementations, the depository media may be at least one of a banknote or a coin. In some implementations, the depository media container may be at least one of a secure bag or a secure envelope. In some implementations, the process 500 may include detecting that the depository media container has been received. The process 500 may include providing, based on the depository media container being received, an indication that the depository media container has been received. In some implementations, the process 500 includes receiving different authentication information associated with a different user. The different user may be associated with a different user account. The process 500 may include authenticating, based on the different authentication information, the different user. The process 500 may include receiving a withdrawal request. The process 500 may include dispensing a portion of the depository media in response to the withdrawal request. The process 500 may include adjusting a balance of the different user account based on the portion of the depository media. In some implementations, the action may include providing a notification based on the declared amount of the depository media not matching the actual amount of the depository media.

Although FIG. 5 shows example blocks of the process 500, in some implementations, the process 500 may include additional blocks, fewer blocks, different blocks, or differently arranged blocks than those depicted in FIG. 5. Additionally, or alternatively, two or more of the blocks of the process 500 may be performed in parallel. The process 500 is an example of one process that may be performed by one or more devices described herein. These one or more devices may perform one or more other processes based on operations described herein, such as the operations described in connection with FIGS. 1A-1C and/or FIGS. 2A-2D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

FIG. 5 is a flowchart of an example process 500 associated with enhanced media processing systems and methods. In some implementations, one or more process blocks of FIG. 5 may be performed by the media processing system 102 and/or the media processing control system 202. Additionally, or alternatively, one or more process blocks of FIG. 5 may be performed by one or more components of the device 400, such as the processor 420, the memory 430, the input component 440, the output component 450, and/or the communication component 460.

Although FIG. 5 shows example blocks of the process 500, in some implementations, the process 500 may include additional blocks, fewer blocks, different blocks, or differently arranged blocks than those depicted in FIG. 5. Additionally, or alternatively, two or more of the blocks of the process 500 may be performed in parallel. The process 500 is an example of one process that may be performed by one or more devices described herein. These one or more devices may perform one or more other processes based on operations described herein, such as the operations described in connection with FIGS. 1A-1C and/or FIGS. 2A-2D. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations.

Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a device, authentication information associated with a user,
wherein the user is associated with a user account;
authenticating, by the device and based on the authentication information, the user;
receiving, by the device, depository media data indicating:
a declared amount of depository media that is contained within a depository media container, and
a unique identifier that associates the depository media container with the user account;
receiving, by the device, the depository media container;
receiving, by the device, a request to deposit the depository media within a collection area,
wherein the request to deposit indicates the unique identifier of the depository media container;
identifying, by the device and based on the unique identifier, the user account;
receiving, by the device, the depository media that is no longer contained within the depository media container;
determining, by the device and based on the depository media, an actual amount of the depository media;
storing, by the device and after determining the actual amount of the depository media, the depository media;
determining, by the device, whether the declared amount of the depository media and the actual amount of the depository media match; and
performing, by the device, an action related to the user account based on whether the declared amount of the depository media matches the actual amount of the depository media.

2. The method of claim 1, wherein performing, by the device, the action based on whether the declared amount of the depository media matches the actual amount of the depository media comprises at least one of:
adjusting, by the device, a balance of the user account based on the declared amount of the depository media and the actual amount of the depository media.

3. The method of claim 1, wherein the depository media is at least one of:
a banknote, or a coin.

4. The method of claim 1, wherein the depository media container is at least one of:
a secure bag, or
a secure envelope.

5. The method of claim 1, further comprising:
detecting, by the device, that the depository media container has been received; and providing, based on the depository media container being received, an indication that the depository media container has been received.

6. The method of claim 1, further comprising:
receiving, by the device, different authentication information associated with a different user,
wherein the different user is associated with a different user account;
authenticating, by the device and based on the different authentication information, the different user;
receiving, by the device, a withdrawal request;
dispensing, by the device, a portion of the depository media in response to the withdrawal request; and
adjusting, by the device, a balance of the different user account based on the portion of the depository media.

7. The method of claim 1, wherein performing, by the device, the action based on whether the declared amount of the depository media matches the actual amount of the depository media comprises:
providing, by the device, a notification based on the declared amount of the depository media not matching the actual amount of the depository media.

8. A media processing system, comprising:
one or more memories; and
one or more processors, communicatively coupled to the one or more memories, configured to:
receive authentication information associated with a user,
wherein the user is associated with a user account;
authenticate, based on the authentication information, the user;
receive depository media data indicating:
a declared amount of depository media that is contained within a depository media container, and
a unique identifier that associates the depository media container with the user account;
receive the depository media container;
receive a request to deposit the depository media within a collection area,
wherein the request to deposit indicates the unique identifier of the depository media container;
identify, based on the unique identifier, the user account;
receive the depository media that is no longer contained within the depository media container;
determine, based on the depository media, an actual amount of the depository media;
store, after determining the actual amount of the depository media, the depository media;
determine whether the declared amount of the depository media and the actual
amount of the depository media match; and
perform an action related to the user account based on whether the declared amount of the depository media matches the actual amount of the depository media.

9. The media processing system of claim 8, wherein the one or more processors, to perform the action based on whether the declared amount of the depository media matches the actual amount of the depository media, are configured to:
adjust a balance of the user account based on the declared amount of the depository media and the actual amount of the depository media.

10. The media processing system of claim 8, wherein the depository media is at least one of: a banknote, or
a coin.

11. The media processing system of claim 8, wherein the depository media container is at least one of:
a secure bag, or
a secure envelope.

12. The media processing system of claim 8, wherein the one or more processors are further configured to:
detect that the depository media container has been received; and
provide, based on the depository media container being received, an indication that the depository media container has been received.

13. The media processing system of claim 8, wherein the one or more processors are further configured to:
receive different authentication information associated with a different user, wherein the different user is associated with a different user account;
authenticate, based on the different authentication information, the different user;
receive a withdrawal request;
dispense a portion of the depository media in response to the withdrawal request; and adjust a balance of the different user account based on the portion of the depository media.

14. The media processing system of claim 8, wherein the one or more processors, to perform the action based on whether the declared amount of the depository media matches the actual amount of the depository media, are configured to:
provide a notification based on the declared amount of the depository media not matching the actual amount of the depository media.

15. A non-transitory computer-readable medium storing a set of instructions, the set of instructions comprising:
one or more instructions that, when executed by one or more processors of a media processing system, cause the media processing system to:
receive authentication information associated with a user, wherein the user is associated with a user account;
authenticate, based on the authentication information, the user;
receive depository media data indicating:
a declared amount of depository media that is contained within a depository media container, and
a unique identifier that associates the depository media container with the user account;
receive the depository media container;
receive a request to deposit the depository media within a collection area,
wherein the request to deposit indicates the unique identifier of the depository media container;
identify, based on the unique identifier, the user account;
receive the depository media that is no longer contained within the depository media container;
determine, based on the depository media, an actual amount of the depository media;
store, after determining the actual amount of the depository media, the depository media;
determine whether the declared amount of the depository media and the actual
amount of the depository media match; and
perform an action related to the user account based on whether the declared amount of the depository media matches the actual amount of the depository media.

16. The non-transitory computer-readable medium of claim 15, wherein the one or more instructions, that cause the media processing system to perform the action based on whether the declared amount of the depository media matches the actual amount of the depository media, cause the media processing system to:
adjust a balance of the user account based on the declared amount of the depository media and the actual amount of the depository media.

17. The non-transitory computer-readable medium of claim 16, wherein the one or more instructions further cause the media processing system to:
detect that the depository media container has been received; and
provide, based on the depository media container being received, an indication that the depository media container has been received.

18. The non-transitory computer-readable medium of claim 16, wherein the depository media is at least one of:
a banknote, or
a coin.

19. The non-transitory computer-readable medium of claim 16, wherein the depository media container is at least one of:
a secure bag, or
a secure envelope.

20. The non-transitory computer-readable medium of claim 16, wherein the one or more instructions further cause the media processing system to:
receive different authentication information associated with a different user, wherein the different user is associated with a different user account;
authenticate, based on the different authentication information, the different user;
receive a withdrawal request;
dispense a portion of the depository media in response to the withdrawal request; and adjust a balance of the different user account based on the portion of the depository media.
